(19) United States
(12) Patent Application Publication
(10) Pub. No.: US 2002/0054957 A1
(43) Pub. Date: May 9, 2002

(54) Paint compositions for coating oil and gas pipes

(76) Inventors: Svend Johnsen, Holte (DK); Richard Witt, Vallensbaek Strand (DK); Muhammad Jamil, Missouri, TX (US); Mia Bacher Olsen, Copenhagen (DK)

Correspondence Address: BIRCH STEWART KOLASCH & BIRCH, PO BOX 747, FALLS CHURCH, VA, 22040-0747, US

(21) Appl. No.: 09/935,673

(22) Filed: Aug. 24, 2001

Related U.S. Application Data
(60) Provisional application No. 60/227,591, filed on Aug. 25, 2000.
(60) Provisional application No. 60/258,617, filed on Dec. 29, 2000.

(51) Int. Cl. B05D 7/22

(52) U.S. Cl. 427/230

(57) ABSTRACT

The present invention relates to an epoxy-based thermally insulating paint composition and its specific use for coating the surface, in particular the inner surface, of oil and gas pipes. The oil and gas pipes thus coated have excellent insulating properties and the formation of undesired waxes or hydrates is significantly reduced. The composition typically comprises 30-70% by solids volume of an epoxy based binder system, 10-50% by solids volume of hollow microspheres, and 1-25% by solid volume of further paint constituents.

### FIELD OF THE INVENTION

The present invention relates to an epoxy-based thermally insulating paint composition and its specific use for coating the surface, in particular the inner surface, of oil and gas pipes. The oil and gas pipes thus coated have excellent insulating properties and the formation of undesired waxes or hydrates is significantly reduced.

### BACKGROUND OF THE INVENTION

Coating and thermal insulation of subsea pipelines is a quite relevant field within the oil and gas industry. The most efficient means of transporting crude oil or natural gas from offshore wells is through subsea or buried pipelines. Besides consideration with respect to corrosion protection, it is also relevant to consider the requirements with respect to thermal insulation to prevent the crude oil or natural gas from producing waxes or hydrates. If the temperature of the pipeline drops below a certain level, heavy components of the crude oil can solidify into a waxy material that can clog the pipeline, and natural gas can form hydrates which also can clog the pipeline.

Current method for thermally insulating oil and gas pipes utilises various types of coats covering the outer surface of such pipes. Examples are given in the recent review by Wilmott et al. (Protective Coating Europe, April 2000, pp 53-60).

GB 2,215,427 describes a coated pipe carrying a moulded coating comprising a polyurethane elastomer and a matrix of polyurethane elastomer having dispersed therein a plurality of discrete hollow units. The coating system is positioned on the outer surface of e.g. pipes. The layers of polyurethane typically have a thickness of approx. 10 mm and 35 mm, respectively.

EP 0 189 720 describes a material for use at high temperatures. The material comprises hollow microspheres in a matrix based on a silicone elastomer or silicone resin.

Pitture Vernici 2000, Vol. 76, pp 21-22 describes the thermally insulating properties of microspheres, e.g. for coating for undersea oil pipelines.

WO 01/02503, which was filed before, but published after the priority dates of the present application, describes pipes or pipelines insulated on their interior surfaces. The insulation may comprise an non-phenolic epoxy and glass/ceramics. A product named “Therma-Coat” from Hempel Coatings, Conroe, Texas, USA, is mentioned as a possible insulation. It is mentioned that the “Therma-Coat”product is a high solids epoxy with a low content of phenolics. It is further mentioned that the “Therma-Coat” insulation may “use microspheres of glass, ceramic spheres, amorphous ceramic or glass shapes, spheroidal ceramic or glass shapes, non-spheroidal ceramics or glass shapes, or combinations thereof”. Ratio ranges for the glass to ceramic content as well as the glass/ceramic to organic matrix content are provided. Another suggested insulation comprises a product called Biotherm® 453 manufactured by TFT, Houston, Tex., USA, combined with hollow glass (micro)spheres. According to the data sheet for the Biotherm® 453 product, is a solvent free (100% solids) epoxy resin in the form of a paste.

However, there is still a demand for efficient paints for thermal insulation to oil and gas pipes.

### SUMMARY OF THE INVENTION

The invention relates to a paint composition comprising 30-70% by solids volume of an epoxy based binder system, 10-50% by solids volume of hollow microspheres, and 1-25% by solid volume of further paint constituents.

The paint of the present invention is believed to provide advantages with respect to application in that the paint coat can be applied in an accurate way, e.g., by spraying. The degree of insulation can easily be programmed by adjusting the dry film thickness of the paint coat.

Furthermore, it is believed that insulating of the inner surface of a tubular conduit, i.e. directly towards the hot crude oil or gas, will minimise the part of the heat loss which will take place in the steel.

The solution provided with the present invention potentially also provides advantages with respect to maintenance of tubular conduits in that it is believed to be possible to repair (if necessary) the coating of the inner surface of the tubular conduit by adapting spraying equipment to conventional equipment (a so-called “pig”). It is believe that in situ “pigging” can be carried out in a number of instances.

The present invention also provides advantages with respect to economy as the coating will provide a smooth inner surface to the tubular conduit. This is a clear advantage since it reduced the energy required for pumping and improves the efficiency of the tubular conduit (Liisberg-Larsen and Bacher Olsen, in Proceedings of The Sixth Mediterranean Petroleum Conference and Exhibition, Nov. 23-25, 1999, page 755). Furthermore, it makes it much easier to clean the inner surface and reduced the clogging up of the inner surface due to the smoothness of the paint coat. Cleaning of pipes is normally done by pigging and it is believed that the extent and frequency of pigging can be reduced.

### DETAILED DESCRIPTION OF THE INVENTION

The present inventors have found that the epoxy-based thermally insulating paint described herein is particularly suitable for the thermal insulation of tubular conduits, e.g., oil and gas pipes. The paint is particularly suited for the coating of the inner surface of a tubular conduit. The coating can also be used in a combination of coating of the inner surface and the outer surface with the same paint composition or with other products, e.g. as described by Willmott et al. (see above). The film-forming paint composition is characterised by a high content of hollow microspheres.

Tubular Conduit

Tubular conduits to which the paint of the present invention are applied are typically made of steel. A tubular conduit comprises a rather well-defined inner surface and an outer surface. When a tubular conduit is use for the transportation of oil or gas, the inner surface is in contact with, or in close proximity of, the oil or gas. The outer surface of the tubular conduit is in contact with the surrounding medium, typically water for subsea oil or gas pipes. As described above, it is desirable to protect the outer surface against corrosion and at the same time provide thermal insulation to the oil or gas so that waxes are not solidified on the inner surface of the tubular conduit or so that hydrates of the gas are not formed. Such protection can be provided by the paint of the present invention.

It should be understood that a tubular conduit within the meaning of the present invention may be a part of a larger tubular conduit structure, i.e. the term “tubular conduit” may also mean a part or section of a larger tubular conduit. One example is a double walled tube for transportation of oil where the joints between sections of double walled tube elements are constituted by single-walled sections. Such sections can be joined by welding or by other means, but the sections may also be parts of one tube, i.e. with no discrete joint there between. In order to obtain a suitable thermal insulation of the larger tubular conduit, it is typically only necessary to provide the paint composition to the single-walled sections. Thus, the larger tubular conduit will have alternate sections thermally insulated by a double wall and by a coat of the paint according to the invention.

This being said, it is envisaged that the paint of the invention can be equally applicable for the thermal insulation of other equipment used in connection with the transportation of oil and gas, e.g. valves, tubes, etc.

Before the application of the paint composition, the outer surface of the tubular conduit may be coated with an anticorrosive paint composition. Alternatively, the outer surface may be provided with a coat of a thermally insulating paint composition, e.g. the paint composition utilised in the present invention. Such a paint coat may also have anticorrosive properties.

Thermal Insulation

The aim of the invention is to provide a thermal insulation to tubular conduits. Thermal insulation is stated either as the k-value or as the U-value. When used herein, the k-value [W/(mK)] is the thermal conductivity of the coating system (possible consisting of multiple layers) whereas the U-value [W/(m²K)] is an expression for the thermal transmittance.

It is desirable and also possible to provide a paint coat which yields a thermal insulation corresponding to a k-value of at the most 0.15 W/(mK), such as at the most 0.10 w/(mK), e.g. at the most 0.08 W/(mK), such as at the most 0.05 W/(mK), in particular a k-value of at the most 0.03 W/(mK). The paint composition described in the examples provides a k-value of 0.12 W/(mK), but it is envisaged that even lower k-values can be obtained by routine optimisation.

The thermal insulation appears to be obtainable as a result of the combination of the film thickness of the paint coat applied and the excellent properties of utilised paint composition.

Film-forming Paint Composition

The epoxy-based paint composition of the present invention is a film-forming paint composition, i.e. the combination of the paint constituents should make it possible to prepare a film of substantially uniform thickness.

Hollow Microspheres

The hollow microspheres to be used within the present invention can be constructed of any material applicable for thermal insulating purposes. Typically, the material constituting, or essentially constituting, the hollow microspheres is either plastics (e.g. based on polyvinylidene chloride, polyacrylic polymers, etc.), ceramic or glass, most often glass.

The mean particle size (outer diameter) of the microspheres is typically 2-200 μm, such as 10-150 μm. The density of the microspheres is not particularly critical but is typically in the range of 0.1-2.5 g/cm². The interior of the microspheres can comprise a heat-insulating fluid, e.g. a low pressure gas (even vacuum) or a gas having low thermal conducting properties. The pressure stability of the microspheres will typically be selected with due regard to the application method.

Among useful examples of commercially available microspheres can be mentioned E-spheres ex Australian Oxides, Filite 52/7/S and Filite 300 ex Filite (Runcorn) Ltd. , U.K., Armospheres CN ex A.M.L. International, U.K., Extendospheres SLG and Extendospheres SG ex PQ Corporation, USA or AWL, Sweden, Scotchlite™ Glass Bubbles (e.g. series S and K), 3 M™ Zeeospheres™ Ceramic (e.g. series G and W) and Z-light Spheres™ Ceramic Microspheres (e.g. series G and W). A more specific example within this class is the Scotchlite™ Glass Bubbles S38 product which yields good thermal insulation and has a high pressure resistance (up to 4,000 psi). Also applicable are the microspheres described in U.S. Pat. No. 5,713,974 which is hereby incorporated by reference.

As mentioned above, the hollow microspheres preferably constitutes 10-70% by solids volume of the paint composition, e.g. 10-60% such as 10-50% by solids volume, preferably 15-50% such as 15-40% by solids volume, in particular 20-40% by solids volume of the paint composition.

Binder System and Other Constituents

The binder system is one of the most important constituents of the paint composition, in particular with respect to the film-forming properties. Besides the film-forming properties, it is relevant that the paint coat resulting from the application of the paint composition to the inner surface of the tubular conduit is crude oil resistant (when the tubular conduit is intended for transportation of oil) or resistant to gas (when the tubular conduit is intended for transportation of gas). The paint coat should furthermore be hard and impact and abrasion resistant. It has been found that the combination of an epoxy-based binder system and the hollow microspheres provides the necessary combination of mechanical and insulating features.

The binder system of a paint composition may comprise one or more epoxy binder components selected from aromatic or non-aromatic, hydrogenated epoxy resins, containing more than one α-(1,2)-epoxy group per molecule, which is placed internally, terminally or on a cyclic structure, together with a suitable curative to act as a cross-linking agent. Combinations with reactive diluents from the classes glycidyl ethers or esters of aliphatic, cycloaliphatic or aromatic compounds can be included in order to reduce viscosity and for improved application and physical properties. The binder system can also include reactive acrylic modifiers such as acrylate monomers and oligomers, reacting with the curative via a Michael-addition reaction. Particularly suitable binder systems are believed to include epoxy and modified epoxy resins of bisphenol A, bisphenol A/bisphenol F, bisphenol F, Novolac epoxies, non-aromatic hydrogenated epoxies, cycloaliphatic epoxies, glycidyl esters and epoxy functional acrylics. Suitable curatives may comprise of one or more of the following: an amine or amino functional polymer selected from the general classes of aliphatic amines and polyamines, polyamides, amidoamides, amidoamines, polyoxyalkylene amines, modified aryl-aliphatic amines, cycloaliphatic amines and polyamines, aromatic amines, Mannich bases, phenalkamines, amino functional silicones or silanes and including epoxy adducts and ketimines thereof. Curatives can also comprise of isocyanates, mercaptans, acrylates, melamines, organic acids and acid anhydrides.

Especially suitable binder systems include epoxy resins (from bisphenol A, bisphenol A/bisphenol F, bisphenol F, Novolac) cured with Mannich Bases and modified polyamides, modified aryl-aliphatic amines and polyoxyalkylene diamine.

The term “epoxy-based binder system” should be construed as the combination of the epoxy resin and any curatives.

The suitable resin systems are not limited to ambient curing compositions but also include those epoxy resins and curatives which require periods of thermal curing, including fusion bonding.

The binder system is, as the hollow microspheres, a predominant constituent of the paint composition to be utilised within the present invention. Typically, the paint composition comprises an epoxy-based binder system constituting 30-80% by solids volume of the paint composition, such as 30-70%, e.g. 40-70%, preferably 45-70% such as 50-70%, by solids volume of the paint composition.

The paint composition may comprise other paint constituents as will be apparent for the person skilled in the art. Examples of such paint constituents are pigments (such as diketo pyrrolo-pyrol, ferro pigments, fluorescent pigments, metallic pigments and flakes), fillers, dyes, additives (plasticizers (such as hydrocarbon resins), surfactants, wetting agents and dispersants, defoaming agents, catalysts, stabilizers, polymerization inhibitors, corrosion inhibitors, coalescing agents, thixothropic agents (such as polyamide waxes) and anti-settling agents).

The paint composition typically comprises a solvent or solvents. Examples of solvents are alcohols such as water, methanol, ethanol, propanol, isopropanol, butanol, isobutanol and benzyl alcohol; alcohol/water mixtures such as ethanol/water mixtures; aliphatic, cycloaliphatic and aromatic hydrocarbons such as white spirit, cyclohexane, toluene, xylene and naphtha solvent; ketones such as methyl ethyl ketone, acetone, methyl isobutyl ketone, methyl isoamyl ketone, diacetone alcohol and cyclohexanone; ether alcohols such as 2-butoxyethanol, propylene glycol monomethyl ether and butyl diglycol; esters such as methoxypropyl acetate, n-butyl acetate and 2-ethoxyethyl acetate; chlorinated hydrocarbons such as methylene chloride, tetrachloroethane and trichloroethylene; and mixtures thereof.

It should be understood that the paint compositions of the invention preferably are solvent-based systems. Thus, the compositions typically comprises at least 1% based on the solid volume of the paint of solvent(s), such as at least 5% based on the solids volume of the paint, e.g. 10% based on the solids volume of the paint.

The composition may furthermore comprise glass flakes (such as silane treated glass flakes) and fibers, e.g. fibres of the type and character described in WO 97/44401 (page 4, line 1, to page 8, line 32) which is hereby incorporated by reference.

It is believe that inclusion of corrosion inhibitors, extenders and/or silanes can be particularly relevant and beneficial. Silica (such as amorphous silica) and silicates (e.g. potassium alumina silicate) are also often relevant as “other paint constituents” in the paint compositions of the invention.

This being said, it is currently believed that particularly preferred paint compositions according to the invention comprise—as a part of the further paint constituents—a small amount of a silane, such as 0.01-5% by solids volume of the paint composition, in particular 0.02-2% by solids volume, of a silane. Particularly preferred types of silanes are those which also comprise epoxy groups, e.g. gamma glycidoxypropyl trimethoxysilane. It is contemplated that the silane may facilitate the wetting of the hollow microspheres, in particular when the hollow microspheres are made of glass.

The content of such other paint constituents it typically in the range of 1-25%, such as 5-25%, in particular 5-20% by solids volume of the paint composition.

Depending on the application technique, it is desirable that the paint comprises solvent(s) so that the solids volume ratio (SVR—ratio between the volume of solid constituents to the total volume) is in the range of 30-100%, preferably 50-96%, in particular 70-96%.

One example of a suitable paint composition which is believed to constitute an additional (broader) aspect of the invention is a paint composition comprising 30-80% by solids volume of an epoxy-based binder system, 10-60% by solids volume of hollow microspheres, and 1-25% by solid volume of further paint constituents.

A particularly interesting composition appears to be one where the binder system is a two component epoxy-based system.

An interesting embodiment of this aspect of the invention relates to a paint composition comprising 45-70% by solids volume of an epoxy-based binder system, 15-50% by solids volume of hollow microspheres, and 5-25% by solid volume of further paint constituents.

A particularly interesting embodiment of this aspect of the invention relates to a paint composition comprising 45-70% by solids volume of an epoxy-based binder system, 25-50% by solids volume of hollow microspheres, and 5-20% by solid volume of further paint constituents.

Currently preferred is more specifically a paint composition comprising 55-65% by solids volume of an epoxy-based binder system, 15-40% by solids volume of hollow microspheres, and 5-15% by solid volume of further paint constituents, in particular a paint composition comprising 55-65% by solids volume of an epoxy-based binder system, 30-35% by solids volume of hollow microspheres, and 8-12% by solid volume of further paint constituents.

Furthermore, another aspect of the invention relates to a method of using the paint composition as defined above for providing thermal insulation to a tubular conduit, the paint coat being applied to the inner surface of the conduit.

Preparation of the Paint Composition

The paint may be prepared by any suitable technique that is commonly used within the field of paint production. Thus, the various constituents may be mixed together using a high speed disperser, a ball mill, a pearl mill, a three-roll mill etc. The paints according to the invention may be filtrated using bag filters, patron filters, wire gap filters, wedge wire filters, metal edge filters, EGLM turnoclean filters (ex Cuno), DELTA strain filters (ex Cuno), and Jenag Strainer filters (ex Jenag), or by vibration filtration. Typically, and with due respect to the mechanical strength of the hollow microspheres, the paint constituents except for the hollow microspheres may be thoroughly mixed and the hollow microspheres may be added subsequently.

For the embodiments where the paint composition is an epoxy paint system constituted by two or more components, the individual components may be prepared separately and mixed before use as will be understood by the person skilled in the art.

Application of the Paint to the Inner Surface of a Tubular Conduit

The paint composition can be applied to the inner surface of a tubular conduit by means of any of the usual techniques used within the paint field such as by means of a brush, a roller, a pad, by dipping, by spraying etc. Preferred applications techniques are spraying, e.g. airless spraying, and by means of a brush or a roller.

The paint according to the invention may be applied to the tubular conduit in one or several successive layers, typically several layers, e.g. up to 15 individual layers, such as up to 10 layers e.g. up to 5 layers, such as 2 to 4 layers. The total dry film thickness (DFT) of the coating applied per layer will typically be up to 600 μm, such as 200 to 600 μm. Thus, the total thickness of the coating will typically be 200 to 2000 μm, such as 400 to 1250 μm, e.g. 750 to 1000 μm. It is envisaged that the coatings can be even thicker than the above, but in most instances more than 400 μm and typically not more than 4000 μm.

As mentioned above, the application is typically performed by spraying, e.g. spraying techniques. In one embodiment, the application is performed by fixing the spraying equipment and moving and rotating the tubular conduit at a substantially uniform speed relative to the spraying nozzle.

### EXAMPLES

Test Methods

K-value test—thermal insulation/ISO 8302 (1991)

Scope

The steady-state heat transfer factor is obtained through flat slab specimens measured by the guarded hot plate apparatus and the calculation of its heat transfer properties.

Equipment

The guarded hot plate apparatus is intended to establish within specimen(s), in the form of uniform slab(s) having flat parallel faces, a unidirectional uniform density of heat flow-rate at steady-state conditions as the one that would exist in an infinite slab bounded by two flat parallel isothermal surfaces.

Preparation

Preparation and conditioning of the specimens shall be in accordance with the appropriate material specifications.

Evaluation

Data obtained is used to calculate the heat transfer factor in W/(mK).

Autoclave test/NACE TM0185-2000

Scope

The corrosion protection of steel tubular goods by a coating may be altered by exposure to elevated temperatures and pressures and by the composition of the corrosive media.

Equipment

An autoclave is a static test vessel used to expose coated test specimens to corrosive environments at elevated temperatures and pressures, so that the effect of such changes may be evaluated. The autoclave shall be rated to a working pressure and temperature with adequate pressure gauges and indicating temperature controllers to withstand the test conditions.

Preparation

All coating material to be tested or compared should be applied in the same type and grade of substrate for a given test series. The size and shape of the test specimens may be varied to conform to the dimensions of the autoclave, but shall provide a minimum of 26 cm² (4.0 in²) of coated surface. At least 25% of the surface shall be exposed to each phase (i.e. hydrocarbon, water and gas) of the test medium when placed in the autoclave.

Evaluation

The test results obtained can be used to compare the performance of various coatings in specific environments. The test specimens shall be compared in both the gaseous and liquid exposure areas with an untested specimen to determine existence of the following: a) Blistering, b) Softening, c) Coating thickness change (swelling), d) Adhesion (to metal and between coats), e) Colour change, f) Metal attack, g) Underfilm creep and h) Intracoat foam or porosity.

Rating Key for Blistering

ASTM D714 “Standard test method for evaluating degree of blistering of paint”. A#10 represents no blistering. A #8 represents the smallest size blister visible with the naked eye. A #6 blister is slightly larger than a #8. A #4 blister is larger than a #6. A #2 blister is the largest. The letters represent the blister frequency: F—Few, M—Medium, MD—Medium Dense, D—Dense.

Rating Key for Film Thickness and Softening

A—No change, B—Slight change, C—Moderate change, D—Severe change

Rating key for adhesion

A—no loss of adhesion, B—Slight loss of adhesion, C—Moderate loss of adhesion, D—Severe loss of adhesion, E—Disbondment

Rating key for metal attack

A—No apparent corrosion, B—Corrosion occurred.

Pull-off Test/ISO 4624-78/ASTM D 4541-95/SIS 184171-87

Scope

This test covers the determination of the pull-off strength of a coating or coating system, by determining the greatest perpendicular force (in tension) that a surface area can bear, before a plug of material is detached. Failure will occur along the weakest plane within the system comprised of the text fixture, adhesive coating system and substrate. As standard, steel panels with a minimum thickness of 8 mm should be used. In other cases e.g. Where the substrate is in risk of being deformed, a steel ring matching the used dolls must be used for stabilisation.

Equipment and Conditions

As standard, in laboratory, the Saeberg Pull-off Tester should be used, but for field use the HATE is recommended. The standard glue is “Standard Araldit” from Akzo Nobel (2 K epoxy), cured for 24 hours. In special cases the fast drying “LOCTITE 415”, cyano-acrylate, cured for one hour, can be used. As standard, the test is performed in the laboratory, 23° C., 50% RH. When field testing, the conditions should be noted.

Preparation

Steel panels are applied relevant coat or coating system, and left to cure for one week. When wet adhesion are to be determined, the panels are left to dry 24 hours before gluing on dolls. For each panel, a minimum of three dolls* must be prepared by degreasing and abrasion to get a rough surface. The same number of spots on each test panel is roughened with sandpaper, the dust is carefully removed and the dry film thickness is measured, before the dolls are glued on. After proper curing time of the glue, the paint film is cut free around the dolls down to the substrate and the dolls are pulled off. Remember the steel ring for deformable panels.

Evaluation

The pull-off value (tensile strength) is noted and for the Saeberg converted in relation ship to the area of the doll. The site and type of rupture is also noted (cohesive/adhesive). If more than 5% of the rupture is related to the glue of the doll, the measurement must be disregarded. The pull-off value is calculated as a mean standard deviation of the (minimum) three measured values. The site and type of rupture is also stated as a mean of the three measurements.

### PREPARATION EXAMPLE 1

Preparation of Component A

Component A was prepared by mixing the following components in the approximate proportions: 28 parts by weight of epoxy resin bisphenol (Epikote 235 ex. Shell) was mixed with 0.6 parts by weight of xylene (ex. Shell), 5.4 parts by weight of polyethylene wax in xylene (Aditix M60 ex. Supercolori), 0.5 parts by weight of hydrogenated vegetable oil (Crayvallac SF ex. Cray Valley), 4.3 parts by weight of red iron oxide (Bayferrox 130M ex. Bayer) and 11.2 parts by weight of potassium alumina silicate (Mica C-3000 ex. KMG) until dissolved. 0.9 parts by weight of colloidal silica (Aerosil R-972 ex. Degussa) was added and the mixture was stirred to 60-65° C. for at least 15 minutes. 12.9 parts by weight of epoxy resin bisphenol (Epikote 235 ex. Shell) and 3.9 parts by weight of methyl ethyl ketone (ex. Exxon) was ground in the mixture. After grinding 0.7 parts by weight of xylene (ex. Shell), 10.2 parts by weight of hollow glass beads (3M S38), 0.7 parts by weight of gamma glycidoxypropyl trimethoxysilane (Silquest A-187 Silane ex. Witco) and 0.4 parts by weight of xylene (ex. Shell) was dispersed in the mixture.

Preparation of Component B

Component B was prepared by mixing the following components in the approximate proportions: 8.3 parts by weight of epoxy cycloaliphatic polyamine adduct (Ancamine 2143 ex. Air products) was mixed with 8.2 parts by weight of epoxy polyamine (Epi Cure 3251 ex. Shell) and 0.1 parts by weight of silicone free polymer solution until dissolved. Finally, 0.5 parts by weight of colloidal silica (Aerosil R-972 ex. Degussa), 1.7 parts by weight of xylene (ex. Shell) and 1.5 parts by weight of methyl ethyl ketone (ex. Exxon) was dispersed in the mixture.

Component A and Component B

Prior to application 4 parts by weight of component A were mixed with 1 parts by weight of component B in order to obtain the test composition. The test composition has a SVR of 87%. The paint composition (Component A+Component B) comprises approx. 60% by solids volume of the epoxy-based binder system, 31% by solids volume of hollow microspheres, and 9% by solids volume of further paint constituents.

Application of Compositions

Steel panels were used for the examples. The blasted steel panel were heated to 120° F. (50° C.) and the first coat was applied in a wet film thickness determined by the desired total film thickness, the desired number of film layers and the SVR (unless otherwise stated). The solvent was allowed to evaporate (flash off) for approximately 15 minutes at ambient temperature before the panel was heated (forced curing) again. The curing was forced for 40 minutes at 140° F. (60° C.) and the steel panels were taken out of the furnace and applied a 2nd coat in a wet film thickness determined by the desired total film thickness, the desired number of film layers and the SVR (unless otherwise stated). Flash off 15 minutes as above. The curing was forced for 40 minutes at 140° F. (60° C.). The 3rd and subsequent coats were applied as for the 2nd coat. The panels were allowed to cure for 1 week. An airless spray apparatus using a large tip (21/1000″) was utilized with an airless pump 24:1; approximately pressure: 75 psi.

Conducted Tests

K-value Test—Thermal Insulation/ISO 8302 (1991)

The total film thickness was 10.77 mm.

Main surface temperature—paint composition according to the invention

| | Mean | |
|---|---|---|
| | temperature | Mean k- |
| Measure- | of samples | value |
| ment | ° C. | W/(mK) |
| 1 | 30.2 | 0.117 |
| 2 | 79.9 | 0.120 |
| 3 | 109.9 | 0.124 |
| 4 | 140.0 | 0.131 |

Main surface temperature—paint composition without hollow microspheres

| | Mean | |
|---|---|---|
| | temperature | Mean k- |
| Measure- | of samples | value |
| ment | ° C. | W/(mK) |
| 1 | 40.2 | 0.195 |
| 2 | 69.9 | 0.195 |
| 3 | 100.0 | 0.213 |
| 4 | 120.0 | 0.212 |
| 5 | 140.1 | 0.225 |

The average k-value for the test composition product was approx. 0.12. The average k-value for a reference (test composition corresponding to the above but without microspheres) was approx. 0.2. This result indicates that the paint composition of the invention has a highly improved thermally insulating effect.

Autoclave Test/NACE TM0185-2000

Five specimens were tested, measuring 1″ wide by 4.5″ long, coated on one side only with the test composition (red composition) and the edges of each specimen were sealed with another Hempadur 1550. The specimens were evaluated for the characteristics listed in section 5.3. Of NACE TM0185-2000, with the exception of colour change, under-creep and porosity. The tests were conducted at a pressure of 1125 psi and 140° F. The following is a listing of characteristics evaluated. A) Blistering, b) Softening, c) Coating thickness—before and after testing, d) Adhesion—after testing and e) Metal attack—corrosion.

The specimens were as follows:

| Specimen | No. of coats | Total DFT (micron) |
|---|---|---|
| A | 1 | 275 |
| B | 2 | 875 |
| C | 2 | 600 |
| D | 3 | 650 |
| E | 3 | 700 |

All specimens (A-E) gave the same results.

| | Blister | | Film | | |
|---|---|---|---|---|---|
| Phase | No. | Softening | thickness | Adhesion | Metal attack |
| Gas | 10 | A | A | A | A |
| Oil | 10 | A | A | A | A |
| 8% NaCl | 10 | A | A | A | A |

Pull-off Test/ISO 4624-78/ASTM D 4541-95/SIS 184171-87

Panels carrying one, two and four coats of the test composition were tested. Values are stated as mean of two measurements.

| | DFT | Pull-off value | |
|---|---|---|---|
| No. of coats | (micron) | (MPa) | Site of rupture |
| 1 | 499 ± 60 | 16 | 100% cohesive |
| 2 | 1363 ± 104 | 10 | 65% Cohesive (1st |
| | | | coat) |
| | | | 30% Cohesive (2nd |
| | | | coat) |
| | | | 5% Adhesive |
| 4 | 828 ± 17 | 5* | 100% Adhesive |
| | | | (3rd coat/4th coat) |

*The pull-off result was low, compared to the other two results. The re-coating conditions probably caused a problem as an adhesive break between the 3rd and the 4th coat was observed.

Compression Test Performed According to ASTM D1621

The test was performed on an approximately 1″ thick coating prepared in the following way: Composition 1 was poured in to an aluminium tray, leveled off and allowed to cure at room temperature for 10 weeks. Samples (3″×1″×1″) were cut and the pressure was applied on the end surface having a size of (1″×1″).

| | >Pounds-Force | >PSI | % Deformation |
|---|---|---|---|
| Composition 1 | 7.138 | 4.504 | 21 |

The test was stopped after reaching approx. 4.500 PSI for what reason the values are reported as (>).

The test is relevant for coatings applied on the inside of pipes. It is a measure of the performance of the coating which is subjected to high pressure due to the flow of e.g. oil. Within the oil industry it is commonly required that the coating should stand a compression of minimum 3200 PSI.

### PREPARATION EXAMPLE 2

Test Composition 2-4

| | Composition 2 | Composition 3 | Composition 4 |
|---|---|---|---|
| Components A | | | |
| Epoxy resin bisphenol | 40.0 | 40.9 | 41.5 |
| Methyl ethyl ketone | 2.7 | 2.8 | 2.8 |
| Polyethylene wax | 7.3 | 7.4 | 7.5 |
| Colloidal silica | 0.9 | 0.9 | 0.9 |
| Red iron oxide | 4.2 | 4.3 | 4.3 |
| Potassium alumina | 10.9 | 11.2 | 11.3 |
| silicate | | | |
| Hollow glass beads | 6.9 | 9.2 | 10.4 |
| Methyl ethyl ketone | 7.9 | 3.6 | 1.1 |
| Glycidoxypropyl | 0.6 | 0.7 | 0.7 |
| trimethoxysilane. | | | |
| Component B | | | |
| Epoxy cycloaliphatic | 8.2 | 8.4 | 8.5 |
| polyamine | | | |
| Epoxy polyamine | 8.2 | 8.4 | 8.5 |
| Silicone free polymer | 0.1 | 0.1 | 0.1 |
| solution | | | |
| Colloidal silica | 0.5 | 0.5 | 0.5 |
| Xylene | 1.7 | 1.7 | 1.7 |
| SVR | 78.2% | 83.8% | 86.8% |
| Solids volume of | 64.7% | 60.0% | 57.9% |
| epoxy based | | | |
| binder system | | | |
| Solids volume of | 25.1% | 30.6% | 33.0% |
| hollow microspheres. | | | |
| Solids volume of | 10.2% | 9.4% | 9.1% |
| further paint | | | |
| constituents. | | | |

Preparation of Component A

Component A was prepared by mixing the following components in the approximate proportions: The epoxy resin bisphenol (Epikote 235 ex. Shell) was mixed with part of the methyl ethyl ketone (ex. Exxon), polyethylene wax in xylene (Aditix M60 ex. Supercolori), colloidal silica (Aerosil R-972 ex. Degussa), red iron oxide (Bayferrox 130M ex. Bayer) and potassium alumina silicate (Mica C-3000 ex. KMG) and the mixture was stirred to 115-125° F. (46-52° C.) for at least 15 minutes. 12.9 parts by weight of epoxy resin bisphenol (Epikote 235 ex. Shell) and the remaining part of methyl ethyl ketone (ex. Exxon) was ground in the mixture. After grinding hollow glass beads (3M S38), 1.1 parts by weight of methyl ethyl ketone (ex. Exxon) and gamma glycidoxypropyl trimethoxysilane (Silquest A-187 Silane ex. Witco) was dispersed in the mixture.

Preparation of Component B

Component B was prepared by mixing the following components in the approximate proportions: epoxy cycloaliphatic polyamine adduct (Ancamine 2143 ex. Air products) was mixed with epoxy polyamine (Epi Cure 3251 ex. Shell) and silicone free polymer solution until dissolved. Finally, colloidal silica and xylene (ex. Shell) was dispersed in the mixture.

Application of Compositions

Steel panels (3″×6″, thickness 1/16″) were used for the example.

Blasted steel panel were heated to 140° F. (60° C.) and the first coat was applied in a wet film thickness determined by the desired total film thickness, the desired number of film layers and the SVR (unless otherwise stated). The solvent was allowed to evaporate (flash off) for approximately 15 minutes at ambient temperature before the panel was heated (forced curing) again. The curing was forced for 15 minutes at 140° F. (60° C.) and the steel panels were taken out of the furnace and applied a 2nd coat in a wet film thickness determined by the desired total film thickness, the desired number of film layers and the SVR (unless otherwise stated). Flash off 15 minutes as above. The curing was forced for 15 minutes at 140° F. (60° C.). Any subsequent coats were applied as for the 2nd coat. The panels were allowed to cure for 1 week. Application by airless spray

Conducted Test

Heat Flux Data Test

| Specimen | Composition | No. of coats | Total DFT (micron) |
|---|---|---|---|
| A1 | 2 | 2 | 975 |
| A2 | 2 | 4 | 1000 |
| B1 | 3 | 2 | 938 |
| B2 | 3 | 4 | 775 |
| C1 | 4 | 2 | 775 |
| C2 | 4 | 4 | 731 |

As heat source was used a hot plate with wood blocks, approximately 2″ high placed on the sides of the plate. The coated steel panel was placed on the wood blocks with the uncoated surface facing down. The system was allowed 1½ hour to stabilise before measurements were taken. Heat flux through the coating in terms of millivolts of electrical resistance across the coating was measured by using a Heat Flux Sensor from Omega Engg. Inc. (Type HFS—4 serial #00045201). Based on the millivolt measurement the heat flow was calculated.

Results

| | | No. of | | Heat flow |
|---|---|---|---|---|
| Specimen | Composition | coats | MilliVolts | (BTU/HR/SQFT/° F.) |
| A1 | 2 | 2 | 1.682 | 1.8819 |
| A2 | 2 | 4 | 0.643 | 0.7194 |
| B1 | 3 | 2 | 1.237 | 1.3840 |
| B2 | 3 | 4 | 0.704 | 0.7876 |
| C1 | 4 | 2 | 0.594 | 0.6646 |
| C2 | 4 | 4 | 0.414 | 0.4632 |

1. The method of using a paint composition for providing thermal insulation to a tubular conduit, the paint coat being applied to the inner surface of the conduit, the paint composition comprising 30-70% by solids volume of an epoxy based binder system, 10-50% by solids volume of hollow microspheres, and 1-25% by solid volume of further paint constituents.

2. The method according to claim 1, wherein the paint composition comprises 30-70% by solids volume of an epoxy-based binder system, 15-50% by solids volume of hollow microspheres, and 5-20% by solid volume of further paint constituents.

3. A method to claim 1, wherein total dry film thickness (DFT) of the paint coat is in the range of 200-2000 μm.

4. A method according to claim 1, wherein the paint coat is applied in up to 10 layers.

5. A method according to claim 1, wherein the thermal insulation of the paint coat corresponds to a k-value of at the most 0.15 W/(mK).

6. A method according to claim 2, wherein the paint composition comprises 45-70% by solids volume of an epoxy-based binder system, 25-50% by solids volume of hollow microspheres, and 5-20% by solid volume of further paint constituents.

7. A method according to claim 3, comprising 55-65% by solids volume of an epoxy-based binder system, 15-40% by solids volume of hollow microspheres, and 5-15% by solid volume of further paint constituents

8. A method according to claim 7, comprising 55-65% by solids volume of an epoxy-based binder system, 30-35% by solids volume of hollow microspheres, and 8-12% by solid volume of further paint constituents.

9. A method according to claim 1, which as one of the further paint constituents comprises silane in an amount of 0.01-5% by solid volume of the paint composition.

10. A paint composition comprising 30-70% by solids volume of an epoxy based binder system, 10-50% by solids volume of hollow microspheres, and 1-25% by solid volume of further paint constituents.

11. A paint composition according to claim 10, comprising 30-70% by solids volume of an epoxy-based binder system, 15-50% by solids volume of hollow microspheres, and 5-20% by solid volume of further paint constituents.

12. A paint composition according to claim 11, comprising 45-70% by solids volume of an epoxy-based binder system, 15-50% by solids volume of hollow microspheres, and 5-25% by solid volume of further paint constituents.

13. A paint composition according to claim 12, comprising 45-70% by solids volume of an epoxy-based binder system, 25-50% by solids volume of hollow microspheres, and 5-20% by solid volume of further paint constituents.

14. A paint composition according to claim 13, comprising 55-65% by solids volume of an epoxy-based binder system, 15-40% by solids volume of hollow microspheres, and 5-15% by solid volume of further paint constituents.

15. A paint composition according to claim 14, comprising 55-65% by solids volume of an epoxy-based binder system, 30-35% by solids volume of hollow microspheres, and 8-12% by solid volume of further paint constituents.

16. A paint composition according to claim 10, wherein the hollow microspheres essentially is constituted by a material selected from plastics, ceramics, and glasses.

17. A paint composition according to claim 10, wherein the mean particle size of the microspheres is 2-200 μm.

18. A paint composition according to claim 10, wherein the binder system comprises one or more binder components selected from epoxy and modified epoxy resins of bisphenol A, bisphenol A/bisphenol F, and bisphenol F, Novolac epoxies, non-aromatic hydrogenated epoxies, cycloaliphatic epoxies, glycidyl esters and epoxy functional acrylics.

19. A paint composition according to claim 18, wherein the binder system comprises one or more binder components selected from epoxy resins of bisphenol A, bisphenol A/bisphenol F, and bisphenol F, Novolac epoxies.

20. A paint composition according to claim 18, wherein the binder systems includes an epoxy selected from epoxy resins (from bisphenol A, bisphenol A/bisphenol F, bisphenol F, Novolac) cured with Mannich Bases and modified polyamides, modified aryl-aliphatic amines and polyoxyalkylene diamine.

21. A paint composition according to claim 20, wherein the binder systems includes an epoxy selected from epoxy resins (from bisphenol A, bisphenol A/bisphenol F, bisphenol F, Novolac) cured with Mannich Bases and modified polyamides.

22. A paint composition according to claim 10, wherein the binder system is a two component epoxy-based system.

23. A paint composition according to claim 10, which can provide a paint coat which yields a thermal insulation corresponding to a k-value of at the most 0.15 W/(mK).

24. A paint composition according to claim 10, which as one of the further paint constituents comprises a silane in an amount of 0.01-5% by solid volume of the paint composition.
